(19) United States
(12) Patent Application Publication
(10) Pub. No.: US 2012/0021306 A1
(43) Pub. Date: Jan. 26, 2012

(54) ACID FUEL CELL CONDENSING HEAT EXCHANGER

(75) Inventors: Joshua D. Isom, South Windsor, CT (US); Kazuo Saito, Glastonbury, CT (US); John W. Kowalski, Chicopee, MA (US); Bryan F. Dufner, West Hartford, CT (US); Sitaram Ramaswamy, West Hartford, CT (US); Ricardo O. Brown, West Hartford, CT (US)

(73) Assignee: UTC POWER CORPORATION, South Windsor, CT (US)

(21) Appl. No.: 13/259,235

(22) PCT Filed: Apr. 8, 2009
(86) PCT No.: PCT/US2009/039852

§ 371 Date: Sep. 23, 2011

(51) Int. Cl. H01M 8/04; H01M 8/06; F25J 3/00; F28F 1/18; F28D 15/00; F28D 7/16

(52) U.S. Cl. 429/413; 165/104.33; 165/104.28; 62/617; 165/182; 429/435

(57) ABSTRACT

A heat exchanger for a fuel cell includes first and second heat exchanger portions that provide a fluid flow passage. The second heat exchanger portion is arranged downstream from the first heat exchanger portion. The first and second heat exchanger portions include a coolant flow passage, which is provided by tubes in one example. The first and second heat exchanger portions are configured to transfer heat between the fluid flow and coolant flow passages. The first heat exchanger portion is configured to provide a first heat transfer rate capacity. The second heat exchanger portion includes a second heat transfer rate capacity that is greater than the first heat transfer rate capacity. In one example, the first heat exchanger portion includes tubes and does not include any fins, and the second heat exchanger includes spaced apart fins supporting the tubes.

### BACKGROUND

This disclosure relates to an acid fuel cell, such as a phosphoric acid electrolyte fuel cell. More particularly, the disclosure relates to a condensing heat exchanger for use in an acid fuel cell.

One type of acid fuel cell uses a phosphoric acid electrolyte. Typically, a condenser is used in conjunction with the phosphoric acid fuel cell to condense and remove water from a gas stream, such as anode or cathode exhaust. One type of condenser heat exchanger uses multiple tubes supported in multiple fins. A coolant flows through the tubes to condense water from the gas stream flowing between the fins. The water vapor in the gas stream includes a small amount of phosphoric acid. The heat transfer fins at an upstream portion of the condenser heat exchanger have exhibited corrosion due to acid condensation on the fins. The fin edge temperature is much higher than the coolant temperature due to the heat resistance through the fin. As a result, the fin edge temperature is typically higher than the water dew point but lower than the acid dew point, which causes strong acid condensation on the fin leading to corrosion build-up.

Corrosion products must be removed during a maintenance procedure to prevent the fins from becoming blocked, which could inhibit the gas stream flow through the condenser heat exchanger. Corrosion-resistant metals, such as stainless steel and HASTELLOY, have been used for the fins and tubes. Use of corrosion-resistant metals has not extended the maintenance interval for removing corrosion products from the condenser heat exchanger to a desired duration, which may be ten years or more.

### SUMMARY

A heat exchanger for a fuel cell includes first and second heat exchanger portions that provide a fluid flow passage. The second heat exchanger portion is arranged downstream from the first heat exchanger portion. The first and second heat exchanger portions include a coolant flow passage, which is provided by tubes in one example. The first and second heat exchanger portions are configured to transfer heat between the fluid flow and coolant flow passages. The first heat exchanger portion is configured to provide a first heat transfer rate capacity. The second heat exchanger portion includes a second heat transfer rate capacity that is greater than the first heat transfer rate capacity. In one example, the first heat exchanger portion includes tubes and does not include any fins, and the second heat exchanger includes spaced apart fins supporting the tubes. In another example, the first and second heat exchanger portions provide different heat transfer rate capacities by providing different open volumes exterior to the tubes and/or fins in each portion.

These and other features of the disclosure can be best understood from the following specification and drawings, the following of which is a brief description.

### BRIEF DESCRIPTION OF THE DRAWINGS

FIG. 1 is a highly schematic view of a portion of an acid fuel cell having a condensing heat exchanger, in accordance with an embodiment of the present disclosure.

FIG. 2 is another schematic view of the condensing heat exchanger shown in FIG. 1, in accordance with an embodiment of the present disclosure.

FIG. 3 is a schematic top view of one example condensing heat exchanger, in accordance with an embodiment of the present disclosure.

FIG. 4 is a schematic top view of another example condensing heat exchanger, in accordance with an embodiment of the present disclosure.

FIG. 5 is a schematic top view of yet another example condensing heat exchanger, in accordance with an embodiment of the present disclosure.

FIG. 6 is a schematic top view of still another example condensing heat exchanger, in accordance with an embodiment of the present disclosure.

### DETAILED DESCRIPTION

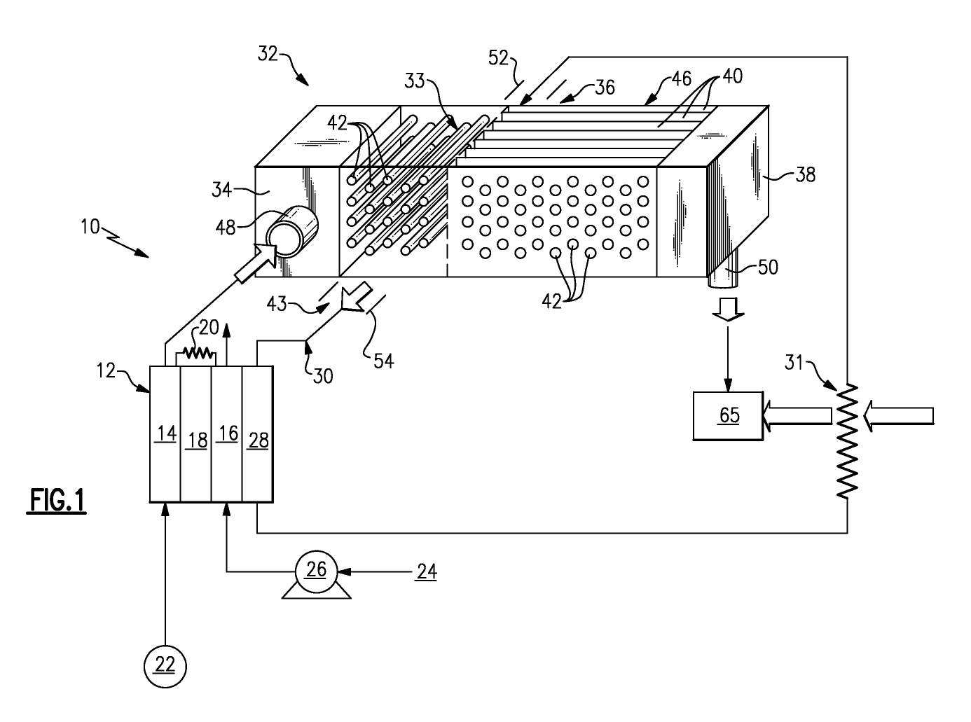

A fuel cell 10 is depicted in a highly schematic fashion in FIG. 1. The fuel cell 10 includes a cell stack assembly 12 having an anode 14 and a cathode 16. In one example, a phosphoric acid electrolyte 18 is arranged between the anode 14 and the cathode 16. The cell stack assembly 12 produces electricity to power a load 20 in response to a chemical reaction. A fuel source 22 supplies hydrogen to a fuel flow field provided by the anode 14. In one example, the fuel source is a natural gas. Components, such as a desulfurizer, a reformer, and a saturator, may be arranged between the fuel source 22 and the anode 14 to provide a clean source of hydrogen. An oxidant source 24, such as air, is supplied to an oxidant flow field provided by the cathode 16 using a blower 26.

The cell stack assembly 12 includes a coolant plate 28, in one example, to cool the cell stack assembly 12 to desired temperature. A coolant loop 30 is in fluid communication with the coolant plate 28 and a condensing heat exchanger 32. A heat exchanger 31 is arranged in the coolant loop 30 to reject heat from the fuel cell 10 to ambient 65. A gaseous stream containing water vapor flows through the condensing heat exchanger 32. In one example, the gaseous stream is provided by anode exhaust from the anode 14. However, it should be understood that a condensing heat exchanger can also be used in connection with the cathode 16.

The condensing heat exchanger 32 includes an inlet manifold 34 providing a fluid inlet receiving the gaseous stream. The gaseous stream flows through a common housing 36 to a fluid outlet in an outlet manifold 38. First and second heat exchanger portions 44, 46 are arranged within the housing 36. The first and second heat exchanger portions 44, 46 provide a fluid flow passage 33 that receives the gaseous stream. In one example, the first and second heat exchanger portions 44, 46 are provided by a tube-in-fin type arrangement. In the example shown in FIG. 1, the first heat exchanger portion 44 does not include any fins to avoid corrosion. More specifically, at least one of the first and second heat exchanger portions 44, 46 include fins 40 that support tubes 42.

In one example, the tubes 42 are illustrated in a horizontal orientation. The fins 40 are illustrated in a vertical orientation such that the tubes 42 are perpendicular to the fins 40. The fins 40 are arranged parallel to one another and include holes to accommodate the passage of the tubes 42 through the fins 40. The tube-in-fin arrangements illustrated in FIGS. 2-5 are similarly configured like FIG. 1, however, those Figures are top views that are more schematic than FIG. 1. The tubes 42 provide a coolant flow passage 43 that extends between a coolant inlet 52 and coolant outlet 54, which are arranged within the coolant loop 30. The coolant inlet and outlet manifolds are not shown for clarity. The fins 40 are spaced apart from and parallel with one another to provide the fluid flow passage 33, which extends between a gas inlet 48 and a gas outlet 50. The tubes 42 and fins 40 can be oriented differently than shown and still fall within the scope of the claims.

In addition to containing water vapor, the gas stream entering the fluid flow passage 33 also contains a small amount of phosphoric acid. Phosphoric acid has a dew point of approximately 160° C., and water vapor has a dew point of approximately 65° C. within the condensing heat exchanger 32. The coolant within the coolant flow passage 43 includes a first temperature, and the fluid, which may be anode exhaust, within the fluid flow passage 33 includes a second temperature that is greater than the first temperature. Coolant flow through the coolant flow passage 43 condenses the phosphoric acid and water vapor within the fluid flow passage 33 onto the exterior of the tubes 42.

Referring to FIG. 2, an acid drip tray 56 below a first portion 44 collects condensed phosphoric acid and supplies the condensed phosphoric acid to an acid return line 66. In one example, a water from the second heat exchanger portion 46 can be supplied to a water return passage 60. The outlet manifold 38 includes a drain 61, for example, that is fluidly connected to the water return passage 60 that supplies the recovered water to a reformer 63. The exhaust gas from the outlet manifold 38 is exhausted to ambient 65 through gas outlet 50 (FIG. 1). A pump 68 supplies the acid from the acid return line 66 to a sprayer 70. The sprayer 70 sprays the acid into a gas stream 74 that is arranged upstream from a gas inlet 76 to a gas flow field 72 within the cell stack assembly 12. In one example, the gas flow field 72 is an anode flow field provided by the anode 14.

The phosphoric acid tends to condense upstream from where the water vapor condenses due to the difference in dew points between phosphoric acid and water. Some water vapor may condense with the acid producing a diluted phosphoric acid. The first heat exchanger portion 44 is designed to extend a length within which a substantial amount of the phosphoric acid condenses.

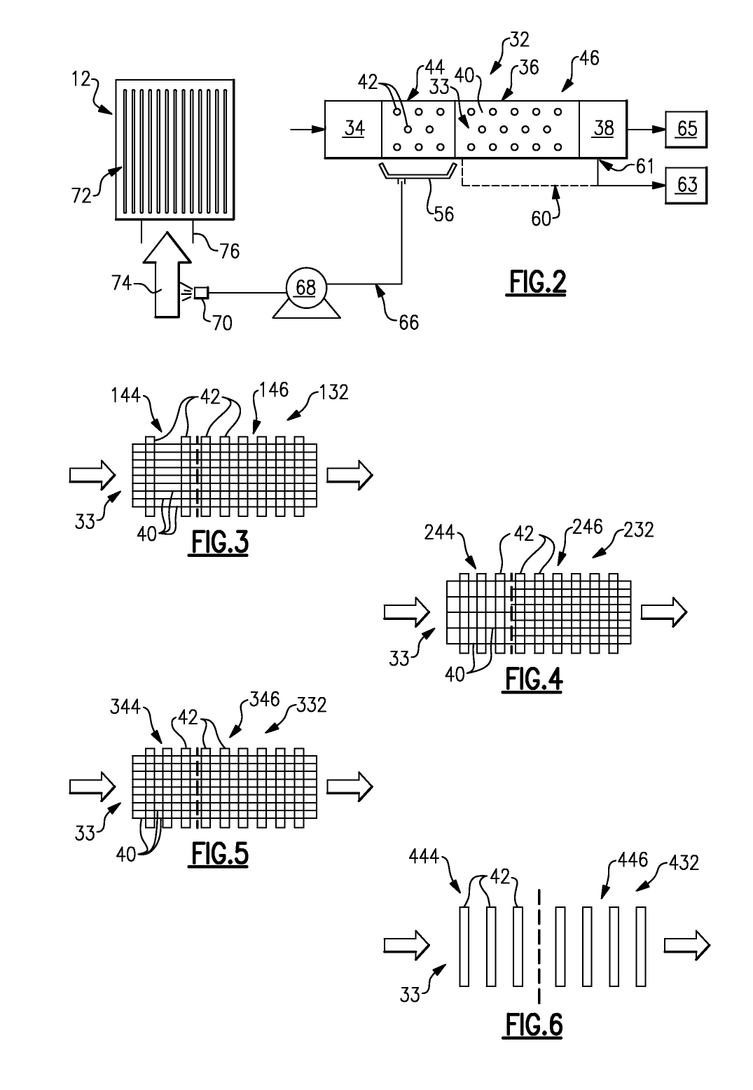

The first heat exchanger portion 44 provides a first heat transfer rate capacity. The second heat exchanger portion 46 includes a second heat transfer rate capacity that is greater than the first heat transfer rate capacity. In this manner, an acid condensation zone is provided in the first heat exchanger portion 44. In the example illustrated in FIG. 1, fins 40 are not provided in the first heat exchanger portion 44 to create a large open area or volume in the first heat exchanger portion 44, which better ensures that if any corrosion forms on the tubes 42 the fluid flow passage 33 will not become obstructed. More generally, the first heat exchanger portion 44 provides a first open volume that is arranged exterior to the tubes 42 and, optionally, fins 40 in the first heat exchanger portion 44. The tubes 42 and fins 40 within the second heat exchanger portion 46 provide a second open volume that is arranged exterior to those tubes and fins and which is less than the first open volume. In one example shown in FIG. 3, the first heat exchanger portion 144 of the condensing heat exchanger 132 includes several tubes 42, but fewer tubes 42 than in the second heat exchanger portion 146. In another example shown in FIG. 4, the first exchanger portion 244 of the condensing heat exchanger 232 includes fewer fins 40 than in the second heat exchanger portion 246.

The first and second heat transfer rate capacities can be achieved in a variety of ways according to this disclosure, for example, as schematically illustrated in FIG. 5. The condensing heat exchanger 332 includes first and second heat exchanger portions 344, 346 that respectively provide the first and second heat transfer rate capacities. For example, the first heat transfer rate capacity can be provided by a first material having a first thermal conductivity, and a second heat transfer rate capacity can be provided by a second material having a second thermal conductivity that is greater than the first thermal conductivity. For example, the first heat exchanger portion 44 can be constructed from a stainless steel, and the second heat exchanger portion 46 can be constructed from a mild steel or aluminum. Since the phosphoric acid is condensed in the acid condensation zone provided by the first heat exchanger portion 44, corrosion of the second material is of considerably less concern than it would be in prior art arrangements. In another example, at least one of the tubes and/or fins within the first heat exchanger portion 44 includes a different geometry than the tubes and/or fins within the second heat exchanger portion 46. For example, the tubes and/or fins can have different thicknesses and/or shapes to achieve different heat transfer rate capacities.

FIG. 6 illustrates a condensing heat exchanger 432 that does not include any fins in the first and second heat exchanger portions 444, 446. The tubes 42, which carry the coolant flow through the fluid flow passage 33, may be bare since acid corrosion many not occur on the tube surface since the acid concentration would be low enough on the surface where water vapor or condensed water exits at lower temperatures for some applications.

Although example embodiments have been disclosed, a worker of ordinary skill in this art would recognize that certain modifications would come within the scope of the claims. For that reason, the following claims should be studied to determine their true scope and content.

1. A heat exchanger for a fuel cell comprising:
first and second heat exchanger portions providing a fluid flow passage with the second heat exchanger portion arranged downstream from the first heat exchanger portion, the first and second heat exchanger portions including a coolant flow passage and configured to transfer heat between the fluid flow and coolant flow passages, the first heat exchanger portion configured to provide a first heat transfer rate capacity and the second heat exchanger portion including a second heat transfer rate capacity that is greater than the first heat transfer rate capacity.

2. The heat exchanger according to claim 1, wherein the first heat transfer rate capacity is provided by a first material having a first thermal conductivity, and the second heat transfer rate capacity is provided by a second material having a second thermal conductivity that is greater than the first thermal conductivity.

3. The heat exchanger according to claim 1, wherein at least one of the first and second heat exchanger portions are provided by a tube-in-fin arrangement, the fluid flow passage provided by between the fins and the coolant flow passage provided by the tubes.

4. The heat exchanger according to claim 3, wherein the fluid flow passage is configured to receive an acid diluted in water, wherein the acid has a first dew point and the water has a second dew point that is less than the first dew point.

5. The heat exchanger according to claim 4, wherein the acid is phosphoric acid.

6. The heat exchanger according to claim 4, wherein the first heat exchanger portion is configured to provide an acid condensation zone with the acid condensing in the acid condensation zone prior to reaching the second heat exchanger portion.

7. The heat exchanger according to claim 6, comprising an acid drip tray arranged beneath the first heat exchanger portion and configured to collect condensed acid from the acid condensation zone.

8. The heat exchanger according to claim 4, wherein the coolant flow passage is configured to receive a coolant having a first temperature, and the fluid flow passage is configured to receive the acid diluted in water at a second temperature greater than the first temperature.

9. The heat exchanger according to claim 3, wherein the tubes and fins within the first heat exchanger portion provide a first open volume that is exterior to the tubes and fins arranged within the first heat exchanger portion, and the tubes and fins within the second heat exchanger portion provide a second open volume that is exterior to the tubes and fins arranged with the second heat exchanger portion, the second open volume that is less than the first open volume.

10. The heat exchanger according to claim 9, wherein first heat exchanger portion has fewer tubes than the second heat exchanger portion.

11. The heat exchanger according to claim 9, wherein the first heat exchanger portion has fewer fins than the second heat exchanger portion.

12. The heat exchanger according to claim 11, wherein the first heat exchanger portion has no fins.

13. The heat exchanger according to claim 3, wherein at least one of the tubes and fins within the first heat exchanger portion has a different geometry respectively than the tubes and fins within the second heat exchanger portion.

14. The heat exchanger according to claim 1, wherein the first and the second heat exchanger portions adjoin one another and are arranged within a common housing.

15. The heat exchanger according to claim 14, wherein the common housing provides a fluid inlet and a fluid outlet with the fluid flow passage arranged there between, and the common housing provides a coolant inlet and a coolant outlet with the coolant flow passage arranged there between.

16. A fuel cell comprising:
a cell stack assembly include an anode and a cathode respectively providing a fuel and an oxidant flow field;
a coolant loop configured to carry a coolant; and
a heat exchanger in fluid communication with one of the fuel and the oxidant flow fields, the heat exchanger including first and second heat exchanger portions providing a fluid flow passage configured to receive a fluid having an acid from one of the flow fields, the second heat exchanger portion arranged downstream from the first heat exchanger portion, the first and second heat exchanger portions including a coolant flow passage in fluid communication with the coolant loop and configured to transfer heat between the fluid flow and coolant flow passages, the first heat exchanger portion configured to provide a first heat transfer rate capacity and the second heat exchanger portion including a second heat transfer rate capacity that is greater than the first heat transfer rate capacity.

17. The fuel cell according to claim 16, wherein the fluid flow passage is configured to receive an acid diluted in water, wherein the acid has a first dew point and the water has a second dew point that is less than the first dew point, the first heat exchanger portion is configured to provide an acid condensation zone with the acid condensing in the acid condensation zone prior to reaching the second heat exchanger portion.

18. The fuel cell according to claim 16, wherein the first and second heat exchanger portions are provided by a tube-in-fin arrangement, the fluid flow passage provided by between the fins, the coolant flow passage provided by the tubes, the first heat exchanger portion having fewer fins than the second heat exchanger portion.

19. The fuel cell according to claim 16, wherein the first and second heat exchanger portions are provided by a tube-in-fin arrangement, the fluid flow passage provided by between the fins and the coolant flow passage provided by the tubes, wherein the tubes and fins within the first heat exchanger portion provide a first open volume exterior to the tubes and fins within the first heat exchanger portion, and the tubes and fins within the second heat exchanger portion provide a second open volume exterior to the tubes and fins within the second heat exchanger portion that is less than the first open volume.

20. A heat exchanger for a fuel cell comprising:
first and second heat exchanger portions providing a fluid flow passage with the second heat exchanger portion arranged downstream from the first heat exchanger portion, the first and second heat exchanger portions including a coolant flow passage and configured to transfer heat between the fluid flow and coolant flow passages, the heat exchanger provided by a tube-in-fin arrangement wherein the tubes and fins within the first heat exchanger portion provide a first open volume exterior to the tubes and fins within the first heat exchanger portion, and the tubes and fins within the second heat exchanger portion provide a second open volume exterior to the tubes and fins within the second heat exchanger portion that is less than the first open volume.
